(19) United States
(12) Patent Application Publication
(10) Pub. No.: US 2026/0260135 A1
(43) Pub. Date: Sep. 3, 2026

(54) LOGICAL REASONING APPARATUS, LOGICAL REASONING METHOD, AND PROGRAM

(71) Applicant: NEC Corporation, Tokyo (JP)

(72) Inventor: Kazeto YAMAMOTO, Tokyo (JP)

(73) Assignee: NEC Corporation, Tokyo (JP)

(21) Appl. No.: 18/873,354

(22) PCT Filed: Jul. 7, 2022
(86) PCT No.: PCT/JP2022/027016

§ 371 Date: Dec. 10, 2024

(51) Int. Cl. G06N 5/04

(52) U.S. Cl. CPC G06N 5/04

(57) ABSTRACT

A logical reasoning apparatus of the present invention includes: an executing means for executing a reasoning process by a reasoning rule on input information, using background knowledge information in which the reasoning rule is represented by one or more logical formulas and query information in which the input information is represented by one or more logical formulas; a monitoring means for monitoring an execution status of the reasoning process and acquiring profile information representing the execution status; and an estimating means for estimating a bottleneck as a candidate based on the profile information, the bottleneck representing a preset problem in execution of the reasoning process.

### TECHNICAL FIELD

The present invention relates to a logical reasoning apparatus, a logical reasoning method, and a program.

### BACKGROUND ART

Deduction, or deductive reasoning is a reasoning mode by which a logical formula (proposition) representing input information and a logical formula (background knowledge) representing a reasoning rule are received and a logical formula (consequence) derived by the reasoning rule from the input information is output.

Abduction, or abductive reasoning is a reasoning mode by which a logical formula (observation) representing input information and background knowledge are received and a logical formula (hypothesis) deriving the input information by a reasoning rule as consequence is output.

Although deductive reasoning and abductive reasoning are theoretically different logical reasoning modes, they are the same in receiving input information and a reasoning rule and outputting a reasoning result, and can be interpreted as essentially the same when implemented on a computer. Therefore, models based on deductive reasoning or abductive reasoning are collectively referred to as logical reasoning models, and a software program that implements computational processing by the logical reasoning model on a computer is referred to as a logical reasoning engine.

Here, Non-Patent Literature 1 discloses a method for implementing weighted abduction, which is one type of abductive reasoning, on a computer. Moreover, Non-Patent Literature 2 discloses a method for implementing Markov Logic Network, which is one type of deductive reasoning, on a computer.

Techniques disclosed in Non-Patent Literature 1 and Non-Patent Literature 2 each employ a procedure in which candidates for a reasoning result are generated from input information and a reasoning rule and an optimal solution is searched for from among the candidates to obtain a final solution. Then, the computational efficiency at this time depends heavily on logical representations used in the given input information and reasoning rule, so that even for similar reasonings in the same domain, the computational efficiency related to the reasonings vary significantly depending on the logical representations used to describe the input information and the reasoning rule.

For example, in the case of writing out a relation “if person x kills person y, person x will be arrested by police z” as a reasoning rule, in the technique disclosed in Non-Patent Literature 2, rather than writhing as one reasoning rule kill (x, y)\hat{ }isPolice (z)⇒arrest(z, x), writing as a plurality of reasoning rules

kill(x, y)⇒isCriminal(x)
isCriminal(x)\hat{ }isPolice(z)⇒arrest(z, x)

will increase the computational efficiency of reasoning based on this knowledge. This is because the technique disclosed in Non-Patent Literature 2 has a feature that computational load increases non-linearly with the number of types of variables individually included in the respective reasoning rules. Therefore, in this case, reducing the number of types of variables included in the individual reasoning rules will increase the overall computational efficiency even if the number of reasoning rules is increased.

### CITATION LIST

### Non-Patent Literature

Non-Patent Literature 1: Naoya Inoue and Kentaro Inui. ILP-based Reasoning for Weighted Abduction. In Proceedings of AAAI Workshop on Plan, Activity and Intent Recognition, pp. 25-32, August 2011.
Non-Patent Literature 2: Richardson, Matt and Domingos, Pedro (2006). Markov Logic Networks. Machine Learning, 62, 107-136, 2006.

### SUMMARY OF INVENTION

### Technical Problem

However, appropriate logical representations vary with factors such as a logical reasoning model and a logical reasoning engine to be used and the behavior of reasoning intended to be realized finally, so that it is essential in building a practical application system based on a logical reasoning model to make adjustments by personnel with in-depth knowledge of the logical reasoning engine, which is a major problem in practical application. That is to say, in building an application system based on a logical reasoning model, it takes time to reason the cause (bottleneck) of the lengthening of a reasoning time, which causes a problem of increase in the number of steps required to build the system.

Accordingly, an object of the present disclosure is to reduce the number of steps required to build a system based on a logical reasoning model, which is the abovementioned problem.

### Solution to Problem

A logical reasoning apparatus as an aspect of the present disclosure includes: an executing means for executing a reasoning process by a reasoning rule on input information, using background knowledge information in which the reasoning rule is represented by one or more logical formulas and query information in which the input information is represented by one or more logical formulas; a monitoring means for monitoring an execution status of the reasoning process and acquiring profile information representing the execution status; and an estimating means for estimating a bottleneck as a candidate based on the profile information, the bottleneck representing a preset problem in execution of the reasoning process.

Further, a logical reasoning method as an aspect of the present disclosure includes: executing a reasoning process by a reasoning rule on input information, using background knowledge information in which the reasoning rule is represented by one or more logical formulas and query information in which the input information is represented by one or more logical formulas; monitoring an execution status of the reasoning process and acquiring profile information representing the execution status; and estimating a bottleneck as a candidate based on the profile information, the bottleneck representing a preset problem in execution of the reasoning process.

Further, a program as an aspect of the present disclosure includes instructions for causing a computer to execute processes to: execute a reasoning process by a reasoning rule on input information, using background knowledge information in which the reasoning rule is represented by one or more logical formulas and query information in which the input information is represented by one or more logical formulas; monitor an execution status of the reasoning process and acquire profile information representing the execution status; and estimate a bottleneck as a candidate based on the profile information, the bottleneck representing a preset problem in execution of the reasoning process.

### Advantageous Effects of Invention

Configured as described above, the present disclosure enables reduction of the number of steps required to build a system based on a logical reasoning model.

### BRIEF DESCRIPTION OF DRAWINGS

FIG. 1 is a block diagram showing the configuration of a logical reasoning apparatus in a first example embodiment of the present disclosure.

FIG. 2 is a flowchart showing the operation of the logical reasoning apparatus disclosed in FIG. 1.

FIG. 3 is a block diagram showing the configuration of a logical reasoning apparatus in a second example embodiment of the present disclosure.

FIG. 4 is a flowchart showing the operation of the logical reasoning apparatus disclosed in FIG. 3.

FIG. 5 is a block diagram showing the hardware configuration of a logical reasoning apparatus in a third example embodiment of the present disclosure.

FIG. 6 is a block diagram showing the configuration of the logical reasoning apparatus in the third example embodiment of the present disclosure.

### DESCRIPTION OF EXAMPLE EMBODIMENTS

### First Example Embodiment

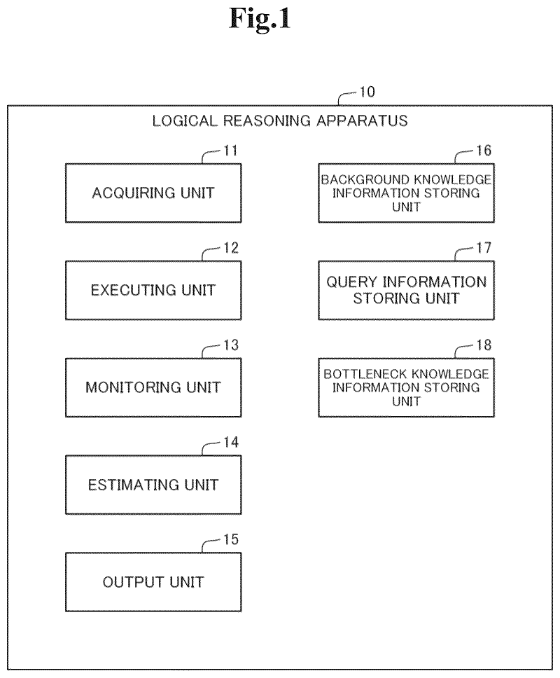

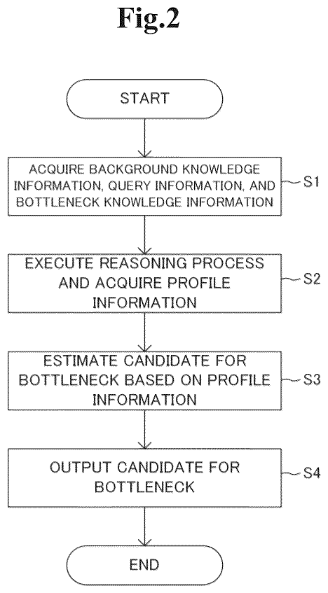

A first example embodiment of the present disclosure will be described with reference to FIGS. 1 and 2. FIG. 1 is a view for describing the configuration of a logical reasoning apparatus, and FIG. 2 is a view for describing the processing operation of the logical reasoning apparatus.

A logical reasoning apparatus 10 in this example embodiment is an apparatus that estimates and presents the cause of lengthening of computation time for a specific input in some logical reasoning engine. The configuration and operation of the logical reasoning apparatus will be described below.

The logical reasoning apparatus 10 is configured with one or a plurality of information processing apparatuses each including an arithmetic logic unit and a memory unit. Then, as shown in FIG. 1, the logical reasoning apparatus 10 includes an acquiring unit 11, an executing unit 12, a monitoring unit 13, an estimating unit 14, and an output unit 15. The respective functions of the acquiring unit 11, the executing unit 12, the monitoring unit 13, the estimating unit 14, and the output unit 15 can be realized by the arithmetic logic unit executing a program for realizing the respective functions that is stored in the memory unit. The logical reasoning apparatus 10 also includes a background knowledge information storing unit 16, a query information storing unit 17, and a bottleneck knowledge information storing unit 18. The background knowledge information storing unit 16, the query information storing unit 17, and the bottleneck knowledge information storing unit 18 are configured with the memory unit.

The acquiring unit 11 acquires background knowledge information representing background knowledge by one or more logical formulas (step S1). The background knowledge information is, for example, stored in advance in the background knowledge information storing unit 16, and the acquiring unit 11 reads and acquires the background knowledge information from the background knowledge information storing unit 16. The background knowledge information is information representing a set of reasoning rules in which if the antecedent is true, then the consequent is true (background knowledge) by one or more logical formulas.

Further, the acquiring unit 11 acquires query information, which is predetermined input information (step S2). The query information is, for example, stored in advance in the query information storing unit 17, and the acquiring unit 11 reads and acquires the query information from the query information storing unit 17. The query information is information representing an observation fact by one or more logical formulas.

Further, the acquiring unit 11 acquires bottleneck knowledge information representing a relation between profile information and bottleneck candidates to be described later in some format (step S1). The bottleneck knowledge information is, for example, stored in advance in the bottleneck knowledge information storing unit 18, and the acquiring unit 11 reads and acquires the bottleneck knowledge information from the bottleneck knowledge information storing unit 18. Specifically, the bottleneck knowledge information is information representing, in any format, a relation in which a specific bottleneck is considered as a candidate when a preset condition is satisfied for profile information representing the execution status of a reasoning process as will be described later. As a considerable specific format, for example, a software program that receives data representing profile information as input and determines whether a condition is satisfied may be held for each bottleneck candidate. In this case, the bottleneck is, for example, information representing the content of a problem in executing a preset reasoning process in the form of a string and, as one example, information that represents the content of a factor that lowers the calculation efficiency of the reasoning process, a factor that increases the calculation time, and the like.

In addition, the acquiring unit 11 may acquire any or all of the background knowledge information, the query information, and the bottleneck knowledge information by reading from the memory unit embedded in the logical reasoning apparatus 10, or may acquire by reading from an external storage device. Moreover, the acquiring unit 11 may acquire any or all of the background knowledge information, the query information, and the bottleneck knowledge information by receiving from another device via a communicating unit. Moreover, the acquiring unit 11 may generate any or all of the background knowledge information, the query information, and the bottleneck knowledge information in response to a user's input operation performed via any input device such as a mouse or a touch panel, and acquire the generated information.

The executing unit 12 (executing means) executes logical reasoning using the background knowledge information and the query information (step S2). That is to say, the executing unit 12 executes a reasoning process by the logical rules of the background knowledge information on the observation fact (input information) that is the query information. The content of the reasoning process varies with a logical reasoning model to be targeted and a logical reasoning engine to be used, but as a specific method, various methods can be applied, such as the hypothetical reasoning mode as described in Non-Patent Literature 1.

The monitoring unit 13 (monitoring means) monitors the execution status of the reasoning process executed by the executing unit 12, and acquires profile information representing the execution status (step S2). Specifically, the monitoring unit 13 monitors a processing state inside the logical reasoning engine executed based on the logical rules by the executing unit 12, and thereby acquires the profile information of computational processing executed by the executing unit 12. The profile information is, for example, statistical information related to the call status of a function inside the logical reasoning engine, and in particular, for a function that takes a logical formula or a reasoning rule as an argument, the profile information has a data format that enables acquisition of statistical information for each logical predicate or reasoning rule corresponding to the argument. In addition, the profile information may be acquired by any means, and if the above conditions can be satisfied in terms of implementation, an existing profiling tool such as GNU Profiler may be used.

The estimating unit 14 (estimating means) estimates and enumerates bottleneck candidates from the profile information and the bottleneck knowledge information (step S3). The bottleneck candidates may be enumerated in any manner. For example, the estimating unit 14 may determine whether the currently targeted profile information satisfies a condition set in correspondence with each of the bottlenecks included in the bottleneck knowledge information, and enumerate bottlenecks that return true as the candidates. Moreover, for example, in a case where a bottleneck is represented as a weight parameter of some statistical analyzer, the estimating unit 14 may determine bottleneck candidates based on the result of mapping the profile information into a vector space by any means and using it as input for statistical analysis.

Here, an example of the bottleneck estimation by the estimating unit 14 will be given. For example, in a case where, in a hypothetical reasoning engine based on the method shown in Non-Patent Literature 1, a reasoning process using a specific reasoning rule is executed with abnormal frequency, that is, the profile information shows that the frequency of execution of the reasoning process of the specific reasoning rule is equal to or more than a threshold value, bottlenecks that may be then suspected include, for example, “the number of reasoning rules that have in their antecedents the same predicate as in the consequents of that reasoning rule is a problem”, or “the argument in the consequent of that reasoning rule is overly abstract, resulting in abnormally large number of combinations of logical formulas to which the reasoning rule can be applied”, and such bottlenecks are estimated as candidates.

Further, another example of the bottleneck estimation will be given. For example, in a case where it is found from the profile information that most of the computation time is spent on a unification process for a certain predicate p, it can be determined that the direct cause is that a large number of logical formulas having predicate p are generated in hypothesis candidates, and therefore, a bottleneck that needs to be found is “the cause of generation of a large number of mutually unifiable logical formulas having predicate p”. In the case of such profile information, the following are possible bottleneck candidates:
Because many combinations of logical formulas to which a reasoning rule that derives a logical formula having predicate p can be applied are present in the hypothesis candidates, a large number of predicates p are generated therefrom.
Because many reasoning rules that derive a logical formula having predicate p are present in the background knowledge information, they are used in the hypothesis candidates, resulting in generation of a large number of logical formulas having predicate p.
The problem is not the number of logical formulas having predicate p, but a fact that they can be unified, and there is a need to impose an exclusive relation between the reasoning rules that derive predicate p (one rule cannot be used in a hypothesis in which the other rule is used).

Further, for example, in a case where it is found from the profile information that most of the computation time is spent on reasoning using a certain reasoning rule A (x)→B (x)\hat{ }C(y), then it can be determined that the direct cause is that “the hypothesis contains a large number of combinations of logical formulas that satisfy B(x)\hat{ }C(y)”, and therefore the following are possible bottleneck candidates:
There is a possibility that a large number of logical formulas having predicate B are generated. By digging deeper therefrom “the cause of generation of a large number of logical formulas having predicate B”, more fundamental bottleneck candidates can be obtained. Specific candidates are the same as those given in the example of unification above.
There is a possibility that a large number of logical formulas having predicate C are generated. The same argument as for predicate B applies here.

The output unit 15 outputs the bottlenecks estimated as candidates in the abovementioned manner, as the candidates for bottlenecks to be corrected in the query information and the background knowledge information (step S4). As an example, the output unit 16 may display the bottleneck candidates on a display panel, or may store the bottleneck candidates in a recording medium that is not shown in the drawings. Moreover, as an example, the output unit 15 may output the bottleneck candidates to another device via an input/output interface or a communication interface.

According to the above configuration, the logical reasoning apparatus automatically estimates and presents a bottleneck in computation time in the logical reasoning process that is performed using the query information and the background knowledge information as input. This enables increase in human time efficiency related to examination of a logical formula compared to manually investigating a bottleneck, and moreover enables reduction of knowledge and skills required for the work.

### Second Example Embodiment

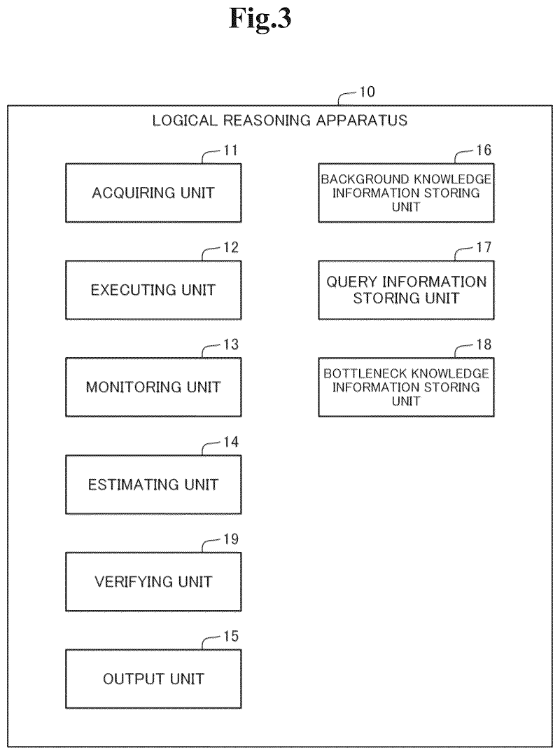

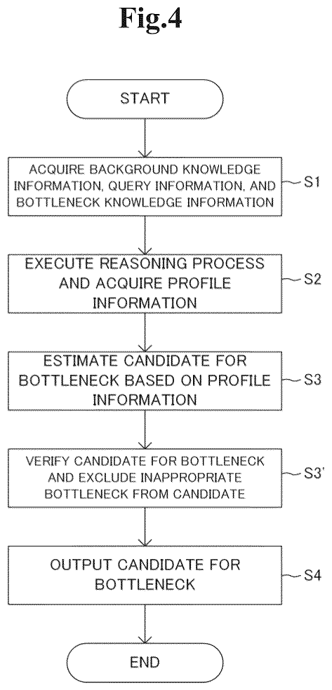

A second example embodiment of the present disclosure will be described with reference to FIGS. 3 and 4. FIG. 3 is a view for describing the configuration of a logical reasoning apparatus, and FIG. 4 is a view for describing the processing operation of the logical reasoning apparatus. Here, components having the same functions as the components described in the first example embodiment will be denoted by the same reference numerals and a description thereof will be omitted as necessary.

As shown in FIG. 3, the logical reasoning apparatus 10 of this example embodiment includes a verifying unit 19 in addition to the configuration of the first example embodiment. Each function of the verifying unit 19 can be realized by the arithmetic logic unit executing a program for realizing each function stored in the memory unit.

The verifying unit 19 (verifying means) determines the consistency of the bottleneck candidates estimated and enumerated by the estimating unit 14 as described above with the query information and the background knowledge information (step S3), and excludes those that are inappropriate as candidates from the bottleneck candidates (step S3′). Any means for determining the consistency may be used and, for example, for each bottleneck, conditions that must be satisfied by the query information and the background knowledge information in order to adopt that bottleneck as a candidate may be set in advance to perform the consistency determination based on whether those conditions are satisfied. That is to say, in a case where neither the query information nor the background knowledge information satisfies the conditions set for each bottleneck, the verifying unit 19 excludes that bottleneck from the candidates. In addition, for example, the verifying unit 19 may map bottleneck knowledge, the query information, and the background knowledge information, respectively, onto a vector space by any means to determine the consistency in accordance with the result of statistical analysis using the vectors as inputs. Then, the output unit 15 outputs the remaining bottleneck candidates after the inappropriate bottlenecks are excluded (step S4).

An example of what the verifying unit 19 excludes from the bottleneck candidates will be shown below. The bottleneck candidates given here are those exemplified above.
Regarding a bottleneck candidate that results from the existence of a large number of reasoning rules deriving logical formulas having predicate p in the background knowledge information, the validity of the bottleneck can be evaluated by directly checking the content of the background knowledge information. That is to say, if there are only a few reasoning rules deriving logical formulas having predicate p in the background knowledge information, for example, if the number of such reasoning rules is equal to or less than a threshold value, then this bottleneck candidate can be rejected.
Regarding a bottleneck candidate that results from the generation of a large number of logical formulas having predicate B, the validity of the bottleneck can be evaluated by directly checking the content of the generated hypothesis candidate. For example, if the number of logical formulas having predicate B included in the hypothesis candidate is not so large, for example, if the number of such logical formulas is equal to or less than a threshold value, then this bottleneck candidate can be rejected.

### Third Example Embodiment

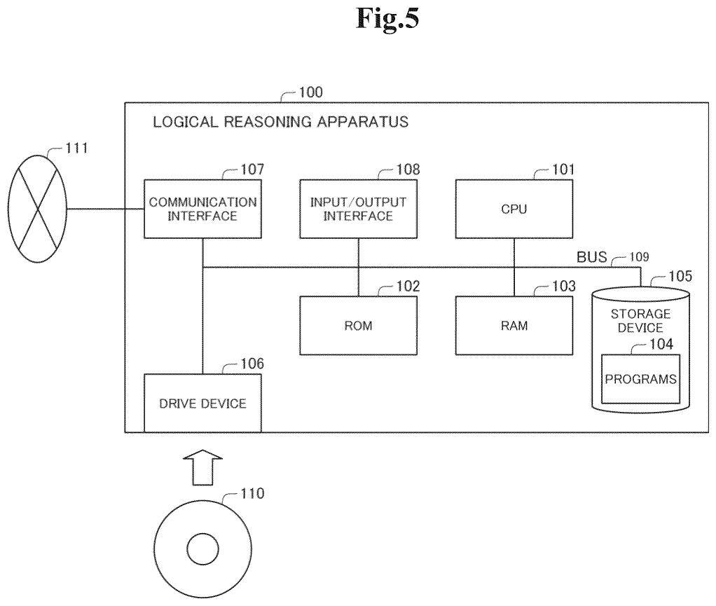

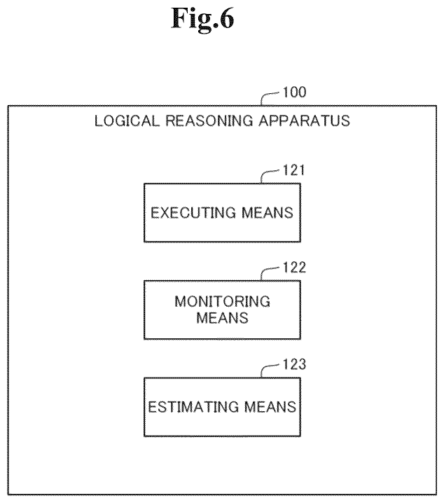

Next, a third example embodiment of the present disclosure will be described with reference to FIGS. 5 and 6. FIGS. 5 and 6 are block diagrams showing the configuration of a logical reasoning apparatus in the third example embodiment. In this example embodiment, the overview of the configuration of the logical reasoning apparatus described in the above example embodiment is shown.

First, the hardware configuration of a logical reasoning apparatus 100 in this example embodiment will be described with reference to FIG. 5. The logical reasoning apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded to the RAM 103;
a storage device 105 storing the programs;
a drive device 106 that reads from and writes into a storage medium 110 outside the information processing apparatus;
a communication interface 107 connected to a communication network 111 outside the information processing apparatus;
an input/output interface 108 that inputs and outputs data; and
a bus 109 connecting the respective components.

Then, the logical reasoning apparatus 100 can build and include an executing means 121, a monitoring means 122 and an estimating means 123 shown in FIG. 6 by acquisition and execution of the programs 104 by the CPU 101. The programs 104 are, for example, stored in advance in the storage device 105 or the ROM 102, and loaded to the RAM 103 and executed by the CPU 101 as necessary. Moreover, the programs 104 may be provided to the CPU via the communication network 111, or the programs 104 may be stored in advance in the storage medium 110 and read by the drive device 106 and provided to the CPU 101. However, the executing means 121, the monitoring means 122 and the estimating means 123 mentioned above may be built by dedicated electronic circuits for realizing such means.

FIG. 5 shows an example of the hardware configuration of the information processing apparatus serving as the logical reasoning apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU

(Micro Processing Unit), an FPU (Floating point number Processing Unit), a PPU (Physics Processing Unit), a TPU (Tensor Processing Unit), a quantum processor, a microcontroller or a combination thereof, instead of the above-mentioned CPU.

The abovementioned executing means 121 executes a reasoning process by a reasoning rule on input information, using background knowledge information in which the reasoning rule is represented by one or more logical formulas and query information in which the input information is represented by one or more logical formulas. The reasoning process by the logical rule is executed based on a logical reasoning model or a logical reasoning engine according to the logical rule.

The abovementioned monitoring means 122 monitors an execution status of the reasoning process and acquires profile information representing the execution status. The profile information is, for example, statistical information related to a call status of a function inside the logical reasoning engine, but may be any information as long as it is information representing an execution status of the reasoning process.

The abovementioned estimating means 123 estimates a bottleneck representing a problem in execution of the reasoning process set in advance, as a candidate, based on the profile information. For example, the estimating means 123 examines for a condition set in correspondence with each bottleneck whether the profile information satisfies the condition, and estimates the bottleneck satisfying the condition as a candidate.

Configured as described above, the present disclosure enables automatic estimation of a bottleneck that causes the lengthening of reasoning time and reduction of the number of works required to build a system.

The abovementioned programs can be stored using various types of non-transitory computer-readable mediums and provided to a computer. Non-transitory computer-readable mediums include various types of tangible storage mediums. Examples of non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory)). The programs may also be provided to the computer by various types of transitory computer-readable mediums. Examples of transitory computer-readable mediums include electrical signals, optical signals, and electromagnetic waves. Transitory computer-readable mediums can provide the programs to the computer via a wired communication path such as an electric wire or an optical fiber, or via a wireless communication path.

Although the present disclosure has been described above with reference to the above example embodiments, the present disclosure is not limited to the above example embodiments. The configurations and details of the present disclosure can be changed in various manners that can be understood by one skilled in the art within the scope of the present disclosure. Moreover, at least one or more of the functions of the executing means 121, the monitoring means 122, and the estimating means 123 described above may be executed by an information processing apparatus installed and connected anywhere on the network, that is, may be executed by so-called cloud computing.

### <Supplementary Notes>

The whole or part of the example embodiments disclosed above can be described as the following supplementary notes. Below, the overview of the configurations of a logical reasoning apparatus, a logical reasoning method, and a program according to the present invention will be described. However, the present invention is not limited to the following configurations.

### (Supplementary Note 1)

A logical reasoning apparatus comprising:
an executing means for executing a reasoning process by a reasoning rule on input information, using background knowledge information in which the reasoning rule is represented by one or more logical formulas and query information in which the input information is represented by one or more logical formulas;
a monitoring means for monitoring an execution status of the reasoning process and acquiring profile information representing the execution status; and
an estimating means for estimating a bottleneck as a candidate based on the profile information, the bottleneck representing a preset problem in execution of the reasoning process.

### (Supplementary Note 2)

The logical reasoning apparatus according to Supplementary Note 1, wherein
in a case where the profile information satisfies a preset condition, the estimating means estimates the bottleneck set in correspondence with the condition as a candidate.

### (Supplementary Note 3)

The logical reasoning apparatus according to Supplementary Note 2, wherein
the estimating means estimates a candidate for the bottleneck from the profile information based on preset bottleneck knowledge information representing a relation between the execution status of the reasoning process and the bottleneck.

### (Supplementary Note 4)

The logical reasoning apparatus according to Supplementary Note 2, wherein
the estimating means estimates a candidate for the bottleneck based on frequency of execution of the reasoning process by the specific reasoning rule.

### (Supplementary Note 5)

The logical reasoning apparatus according to Supplementary Note 1, wherein
the monitoring means acquires, as the profile information, a call status of a function set in accordance with the reasoning rule by execution of the reasoning process.

### (Supplementary Note 6)

The logical reasoning apparatus according to Supplementary Note 1, comprising
a verifying means for, in a case where neither the background knowledge information nor the query information satisfies preset conditions for the bottleneck estimated as the candidate, excluding the bottleneck from the candidates.

### (Supplementary Note 7)

A logical reasoning method comprising:
executing a reasoning process by a reasoning rule on input information, using background knowledge information in which the reasoning rule is represented by one or more logical formulas and query information in which the input information is represented by one or more logical formulas;
monitoring an execution status of the reasoning process and acquiring profile information representing the execution status; and
estimating a bottleneck as a candidate based on the profile information, the bottleneck representing a preset problem in execution of the reasoning process.

### (Supplementary Note 8)

The logical reasoning method according to Supplementary Note 7, comprising
in a case where the profile information satisfies a preset condition, estimating the bottleneck set in correspondence with the condition as a candidate.

### (Supplementary Note 9)

The logical reasoning method according to Supplementary Note 8, comprising
estimating a candidate for the bottleneck from the profile information based on preset bottleneck knowledge information representing a relation between the execution status of the reasoning process and the bottleneck.

### (Supplementary Note 10)

The logical reasoning method according to Supplementary Note 8, comprising
estimating a candidate for the bottleneck based on frequency of execution of the reasoning process by the specific reasoning rule.

### (Supplementary Note 11)

The logical reasoning method according to Supplementary Note 7, comprising
acquiring, as the profile information, a call status of a function set in accordance with the reasoning rule by execution of the reasoning process.

### (Supplementary Note 12)

The logical reasoning method according to Supplementary Note 7, comprising
in a case where neither the background knowledge information nor the query information satisfies preset conditions for the bottleneck estimated as the candidate, excluding the bottleneck from the candidates.

### (Supplementary Note 13)

A computer-readable storage medium storing a program comprising instructions for causing a computer to execute processes to:
execute a reasoning process by a reasoning rule on input information, using background knowledge information in which the reasoning rule is represented by one or more logical formulas and query information in which the input information is represented by one or more logical formulas;
monitor an execution status of the reasoning process and acquire profile information representing the execution status; and
estimate a bottleneck as a candidate based on the profile information, the bottleneck representing a preset problem in execution of the reasoning process.

### REFERENCE SIGNS LIST

10 logical reasoning apparatus
11 acquiring unit
12 executing unit
13 monitoring unit
14 estimating unit
15 output unit
16 background knowledge information storing unit
17 query information storing unit
18 bottleneck knowledge information storing unit
19 verifying unit
100 logical reasoning apparatus
101 CPU
102 ROM
103 RAM
104 programs
105 storage device
106 drive device
107 communication interface
108 input/output interface
109 bus
110 storage medium
111 communication network
121 executing means
122 monitoring means
123 estimating means

What is claimed is:

1. A logical reasoning apparatus comprising:
at least one memory storing instructions; and
at least one processor configured to execute the instructions to:
execute a reasoning process by a reasoning rule on input information, using background knowledge information in which the reasoning rule is represented by one or more logical expressions and query information in which the input information is represented by one or more logical expressions;
monitor an execution status of the reasoning process and acquire profile information representing the execution status; and
estimate a bottleneck as a candidate based on the profile information, the bottleneck representing a preset problem in execution of the reasoning process.

2. The logical reasoning apparatus according to claim 1, wherein the at least one processor is configured to execute the instructions to
in a case where the profile information satisfies a preset condition, estimate the bottleneck set in correspondence with the condition as a candidate.

3. The logical reasoning apparatus according to claim 2, wherein the at least one processor is configured to execute the instructions to
estimate a candidate for the bottleneck from the profile information based on preset bottleneck knowledge information representing a relation between the execution status of the reasoning process and the bottleneck.

4. The logical reasoning apparatus according to claim 2, wherein the at least one processor is configured to execute the instructions to
estimate a candidate for the bottleneck based on frequency of execution of the reasoning process by the specific reasoning rule.

5. The logical reasoning apparatus according to claim 1, wherein the at least one processor is configured to execute the instructions to
acquire, as the profile information, a call status of a function set in accordance with the reasoning rule by execution of the reasoning process.

6. The logical reasoning apparatus according to claim 1, wherein the at least one processor is configured to execute the instructions to
in a case where neither the background knowledge information nor the query information satisfies preset conditions for the bottleneck estimated as the candidate, exclude the bottleneck from the candidates.

7. A logical reasoning method comprising:
executing a reasoning process by a reasoning rule on input information, using background knowledge information in which the reasoning rule is represented by one or more logical expressions and query information in which the input information is represented by one or more logical expressions;
monitoring an execution status of the reasoning process and acquiring profile information representing the execution status; and
estimating a bottleneck as a candidate based on the profile information, the bottleneck representing a preset problem in execution of the reasoning process.

8. The logical reasoning method according to claim 7, comprising
in a case where the profile information satisfies a preset condition, estimating the bottleneck set in correspondence with the condition as a candidate.

9. The logical reasoning method according to claim 8, comprising
estimating a candidate for the bottleneck from the profile information based on preset bottleneck knowledge information representing a relation between the execution status of the reasoning process and the bottleneck.

10. The logical reasoning method according to claim 8, comprising
estimating a candidate for the bottleneck based on frequency of execution of the reasoning process by the specific reasoning rule.

11. The logical reasoning method according to claim 7, comprising
acquiring, as the profile information, a call status of a function set in accordance with the reasoning rule by execution of the reasoning process.

12. The logical reasoning method according to claim 7, comprising
in a case where neither the background knowledge information nor the query information satisfies preset conditions for the bottleneck estimated as the candidate, excluding the bottleneck from the candidates.

13. A non-transitory computer-readable storage medium storing a program comprising instructions for causing a computer to execute processes to:
execute a reasoning process by a reasoning rule on input information, using background knowledge information in which the reasoning rule is represented by one or more logical expressions and query information in which the input information is represented by one or more logical expressions;
monitor an execution status of the reasoning process and acquire profile information representing the execution status; and
estimate a bottleneck as a candidate based on the profile information, the bottleneck representing a preset problem in execution of the reasoning process.
